(19) United States
(12) Patent Application Publication
(10) Pub. No.: US 2011/0104646 A1
(43) Pub. Date: May 5, 2011

(54) Progressive synthetic phonics

(76) Inventor: James Richard Harte, Kansas City, MO (US)

(21) Appl. No.: 12/589,878

(22) Filed: Oct. 30, 2009

(51) Int. Cl. G09B 17/00; G09B 19/00

(52) U.S. Cl. 434/167

(57) ABSTRACT

Synthetic phonics is where the beginning reader first learns the “parts” of words or: 1.) the visual images letters; 2.) the names of the letters; and 3.) also learns the brief spoken sounds (phonemes) assigned to each letter and to each digraph.

And what I have added in this invention, is that the brief spoken sound of a letter (its phoneme) can be put into written form by several side by side printed letters that when blended together, give that letter's approximate brief spoken sound. And then these printed letter clusters can be printed under the individual letters of a word to help a beginning reader understand the approximate brief spoken sounds (phonemes) of the letters in that word.

And then the other parts of English phonics can be learned in a progressive or step by step way.

| U.S. Patents: | Name | Date Issued | Classes & Subclasses |
|---|---|---|---|
| 3,747,229 | Harte | Jul. 24, 1973 | 434/334 & 434/363 |
| 3,964,i76 | Harte | Jul. 22, 1976 | 434/334 & 434/363 |

A variation of the above patents is shown in FIGS. 17 & 18 in this patent
application.

| A patent search produced the following: | | | Classes & Subclasses |
|---|---|---|---|
| 2,361,154 | Schoolfield | Oct. 24, 1944 | 434/176 |
| 3,407,515 | Pitman | Oct. 29, 1966 | 434/185 & 283/46 |
| 4,030,211 | McGinley | Jun. 21, 1977 | 434/167 |
| 4,115,932 | Charlesworth | Sep. 26, 1978 | 434/176 |
| 4,193,212 | Al-Kufaishi | Mar. 18, 1980 | 434/178 |
| 4,713,008 | Stocker | Dec. 14, 1987 | 434/176 |
| 5,429,513 | Diaz-Plaza | Jul. 4, 1995 | 434/167 & 273/303 & |
| | | | 434/169 & 434/169 |
| 6,077,080 | Rai | Jun. 20, 2000 | 434/170 & 434/159 & |
| | | | 434/167 |
| 7,004,758 | Su | Feb. 28, 2006 | 434/178 & 434/156 & |
| | | | 434167 |
| 7,292,971 | Su | Nov. 6, 2007 | 704/5 & 434/156 & |
| | | | 434178 |

No Federal Funds were used in any way in researching or in the development of the this invention: Progressive Synthetics Phonics.

Reference to “Sequence Listing”. The only specific computer program used to obtain background information for this invention was a web via Google, to look up the web site:—donpotter.net—to obtain information about: Hazel Logan Loring, and her 27 page monograph: Reading Made Easy With Blend Phonics in First Grade. published in 1980. In this booklet, Hazel Logan Loring advocates speaking the Schwa sound of uh to give some consonants their closest spoken sound. But Ms. Loring does not put this uh into print following some consonants. Rather, she notes in her booklet, that it is difficult to speak many consonant spoken sounds in isolation, so add the spoken sound of uh to get the approximate spoken sound. And I have taken the liberty to put that uh spoken sound in print below some consonants. Another valuable source of information about the various consonant spoken sounds in English words is in the book: Linguistics and the Teaching of Reading, by Carl A Lefevere, published in 1964. In this book Carl A. Lefevere makes many good observations about the English Language. He notes for instance that a phoneme is not one single specific spoken sound, but is rather a class of closely related spoken sounds. And that consonant spoken sounds are often influenced by the spoken sounds of other consonant sounds or vowel sounds that are next to it in a spoken word. And Carl A. Lefevere notes that consonants have three main types of spoken sounds which he classifies into: 1.) stops; 2.) fricatives; and 3.) resonants or continuants. And Carl A. Lefevere does not try to have these three classes of consonant spoken sounds (phonomes) put into print. So I have taken Carl Lefeveres' concepts and the observations of Hazel Logan Loring, and used them to come up with printed letter clusters of: 1, 2, or 3 letters that when blended together give the “approximate” brief spoken sounds of consonant and vowel phonemes. (Thus my claims to this invention) And I have simplified Carl A Lefevere's three main types of Consonants, by re-classifying fricatives into either: 1.) Stops, or 2.) resonants or continuants. (This lessens their complexity for beginning readers of English words.) And “stop” consonants abruptly stop their sound. And we can add the Schwa sound of -uh to a stop consonant to approximate its spoken sound. And resonant or continuant consonants, are those consonants such as: f, l, m, n, r, s, and z, whose spoken sound may continue in a resonant or rhythmical manner to approximate their spoken phoneme; such as: f=f-f-f, l=l-l-l, m=m-m-m, n=n-n-n. s-1=s-s-s, s-2=z-z-z, and z=z-z-z.

And I found the quickest way to get information is via the web or internet with Google's search engine

Background of the Invention. When I was in the U.S. Army in 1946 and 1947, I was able to visit, and/or live in: Pearl Harbor, in Honolulu, Hi.; Naha, Okinawa; Seoul and Chunchoon, Korea; and Yokohama, Japan, as a part of my assignments in the U.S. Army. And I saw much destruction from World War Two. And I thought many people are crazy in various ways that caused them to behave in destructive ways to others, and in time, to the citizens of their own country.

And as I thought about the above observations, I thought that trying to find out why people and sometimes nations behaved in crazy ways at times, might be an interesting area of work. And in time this led me to go to medical school; and then into the medical specialty of psychiatry. And as I talked with my adult patients, I wondered what events in their childhood and adolescence may have played a significant role in their mental illness. And I sometimes asked my patients directly this question.

And the question of possible childhood events playing a role in later major mental illness in adults influenced me to take a fellowship in child and adolescent psychiatry from July 1960, to July 1962.

And from 1957, until I retired in 2003, I found, year after year, that about 50% of the children and adolescents that I was asked to see and evaluate for a wide variety of: behavior, attention, mood, impulse control, emotional, and/or thought problems, also had a major problem with reading English words and sentences. And most of these children had intelligence in the average range, and some had superior intelligence.

And for many years I kept in my desk a reading test called: The Silvaroli Informal Reading Survey. And with a cooperative child or adolescent, in fifteen to twenty minutes, you could get their: 1.) English Word Recognition Grade Level; and 2.) their Sentence Comprehension Grade Level. And with another brief test, you could find out in five minutes how well they understood English phonics.

In the USA, in fifth grade and higher, children and adolescents are expected to be able to read multiple syllable English words. And if you don't understand English phonics, sounding out multiple syllable English words are often a series of mysteries to you, and you often feel lost. But with sufficient one to one help or tutoring in reading, many reading impaired children and adolescents can learn English phonics, and then be able to “sound out” multiple syllable words in a phonic way.

And to find out why so many children were having major problems with learning to read, I started enrolling in graduate education courses in the evenings, in reading and related topics, in the School of Education, in 1970 at the University of Missouri at Kansas City. And by 1980 I had acquired 95 graduate hours, mostly in Education, Reading, Educational Research, and related topics at U.M.K.C.

And at U.M.K.C., I met many educators who were pleased to meet a child psychiatrist who was interested in education and the problems children were having with learning to read. And one result was that at their invitation I increased my work as a paid child psychiatric consultant to four school districts in the Kansas City area. And a part of the outcome was that I ended up searching for a “better way” to help children learn to read English words.

And one outcome of my search was that in the early 1970's I developed or invented a simple mechanical teaching machine that gives immediate feedback to the user as to their correct and incorrect responses to a wide variety of questions. Please see drawings #16, 17, & 18 in this current invention for some of the details of this earlier 1970's invention.

And in the late 1970's, and early 1980's, I talked with some of the education administrators in the school districts where I was a consultant about having this teaching machine and related instructional sheets evaluated in a research—statistical—controlled study. And initially several administrators were enthusiastic about such a study. But when it came down to looking at the amount of “teacher time” (and money) this study would take, they did not have the money in their budgets. And they wanted me to pay the all of the costs of such a study. And I did not have that kind of money either.

And I continued to be a consultant to several school districts until about the mid 1980's. One problem was that after the school year was over in June of each year, I increased my work—consultation time—with psychiatric hospitals, and residential treatment centers. And then when September arrived, I found I had less time to work for school districts, as my work time had been committed elsewhere.

And I did make one marketing effort to sell my “Feedback Teaching Machine” and related sets of English phonics, to school districts, via special education programs. But I lost money on this business adventure. So I put my “Feedback Teaching Machine and related sets of instructional sheets “on the shelf” until a later time, such as after I retired.

My primary goal in developing instructional sheets for the Feedback Teaching Machine was to develop sets of instructional sheets that would help children who were non-readers to better understand the English phonics of three and four letter English words. And to illustrate a word, I choose words that you could illustrate by a picture of an object or a picture of an action. And in the 19703 s I collected and used as a starting point 120 three letter words that were easy to illustrate by a picture. And between 1980, and 2000, I located an additional 40 three letter words of objects or actions that were easy to illustrate by a black and white picture. This gave me a total of 160 three letter words and related pictures by the year 2000. Please refer to FIGS. 8 and 9 for a listing of these 160 three letter words.

One day in the late 1980's I was talking with a friend of many years, John Shipper MD, who had retired to La Union Province in Philippines. And I mentioned my desire to still have my Feedback Teaching Machine evaluated in a small research way, to see if it made a difference in helping children learn to read by mastering the phonic sounds of the letters in three letter words.

As I saw the situation, three letter words were the shortest and simplest English words, in terms of their phonic make up. So this made three letter words a good place to start with in learning English Phonics. And my friend, John Shipper, said to me: “Bring your teaching materials to the Philippines, and we can have them evaluated there, and produced there for less money than in the U.S.A.”

And I followed John Shipper's advice. And for many years I spent about two weeks a year in the Philippines talking with educators, about my ideas and materials. And in time I was able to gain the cooperation of one Provincial Education Supervisor. But we had to do the study his way, with me providing the materials. But this turned out to be a flawed study. The goal was to see if about 140 second grade students in one elementary school, who used my instructional materials for two—twenty minute periods per day, had superior scores in reading simple English words after one semester, as compared to about 150 second grade students in a second elementary school who did not use my materials.

Fortunately before the study started we tested all second grade students in both schools, as to their ability to read 50 simple English words from the Dolch Word List. And we used a “split half” type of study with the first 100 Dolch Words. Here the children of both schools got the even numbered words as a base line tests. And they got the odd numbered words after one semester where the second graders in one school were to work with my materials for 20 minutes twice a day.

And what was the outcome? The outcome was that the “control group” of about 150 second grade students performed better on the second half of the Dolch Word List, in reading these words, and knowing what these words meant.

But then we looked at the base line studies. And we found that the “control group” had far superior scores in recognizing English words, and knowing their meanings even before the study started. So this was a flawed study. (The two samples did not score the same at the start of the study. And the control group had far superior scores on English word recognition and English word meaning at the onset of the study.)

But there was a very interesting and unplanned and indirect outcome to this study. As we were going over the details as to how to use these materials to help children learn to read English three letter words, one mother brought her four year old son and her three year old daughter to some of the meetings. And this four year old boy liked to “play with” the materials. And at one of our last meetings before I returned to the USA, this four year old boy asked me if he could take some of these materials home and “play with them there.” And I granted his request. And his parents told him he could “play with these materials” daily, providing he stayed with them for one hour per day on week days. And one parent or the other was around to supervise him.

And two years later when this boy started first grade, he was reading English words quite well. And frequently through his first grade school year, he would bring one of the books he was reading at home to school, and read parts of it to his 60 classmates. And after reading a sentence or two in English, he would then translate these spoken words into the local language of Ilocano, and/or into the National Language of Philipina, (expanded Tagalog—the language spoken around Manila)

And this boy's first grade teacher would then write these English words and sentences on the black board. And under the English words and sentences she would write the translations into Ilocano, and into Philipina.

And the father of this boy belonged to the local Rotary Club. And a number of Rotary Club members had heard about his son's amazing ability to read English words. And half way through first grade his parents consented to his educational testing in reading English words. And when tested, he was between fifth grade and sixth grade in English word recognition skills and in English sentence comprehension skills.

And the local Rotary Club appointed a committee to study what to do with this information. And they formed a literacy committee. And members of this literacy committee contacted a number of Child Day Care Centers for pre-school age children, ages 3 through 6 years, that were in their community, about their interest in teaching their preschool age children to read English words.

And I got an e-mail asking me for permission to use the materials I had developed, to use them with the children in 25 Day Care Centers in this community. And I e-mailed a response back saying that I thought that I had only about a dozen of the feedback teaching machines at the home of my friend, John Shipper. But they were welcome to have these 12 teaching machines. And I also included the information that I had the same 160 three letter words printed with a single picture of each word, printed on 8.5″×11″ sheets of paper. And that these printed sheets could be easily and rapidly duplicated by a black and white copying machine.

And I said via e-mail, that I would be over in that community in about two months, and that would be glad to talk with the teachers or workers in these 25 Child Day Care Centers. And that I would try to use a copying machine that I had purchased in that community and that was available near the home of my friend John Shipper.

And on this trip, I met with the staff of the 25 Child Day Care Centers, plus their administrative staff, plus educators who taught English and elementary education at a local college, and at a local university. And in addition I met with a number of supervising staff from some of the local elementary schools.

And at this meeting I gave each of the Child Day Care Center Staff and each administrative staff person, 160 printed pages (80) sheets, where printed on each page was a picture of an object or an action, and below each picture was its three letter printed word. And the local college and university level educators arranged for several future workshops to go over these 160 pages (80 sheets) with the child day care staff, to explain how to best use these sets of sheets.

And on my next trip to this Philippine community about six months later, I was told that a meeting had been arranged for two days after my arrival, where I was to meet with the staff of the Child Day Care Centers. However the number of people at this meeting had about doubled from the number at my previous meetings. (And I had been told prior to this meeting that there were actually over fifty Child Day Care Centers in this community.) And I was greeted at this meeting with the repeated question: “Where are our materials to help teach English Words to our children.?” And fortunately I had been forewarned of this likely request. And I told members of this meeting that I still had about two weeks left to spend in the Philippines; and I would try to print, or have printed up, the same or similar materials for those child day care staff persons who had not received any of these materials previously.

But I also told these Child Day Care Center Workers from the 50+ centers that I would like for them to later test and evaluate their children's progress at some point in time in the future, to see how well these children from 50+ child care centers were learning the spoken sounds assigned to the letters of the 160 English three letter words.

And I told them that I would develop these tests, and pay a small amount of money to the tester, for each test that was adequately completed. And I told them, that what I had in mind was what I called a “Six Part Test”. (This Six Part Test is similar to the eight part “Review and Test Sheet” illustrated in FIG. 14, as a part of this patent application. But this “Six Part Test” lacks the contents of columns 6 & 7. In this current invention.)

In these 160 pages with one picture per page, each picture has its printed three letter name printed below that picture. And I had these 160 pages with their three letter words arranged in an alphabetic sequence from A to Z, and numbered from #1 to #160. And at the time I arranged them in this “A to Z” alphabetic sequence, I did not realize the problems this A to Z alphabetic sequence would create for these children and for the Child Day Care Workers at the 50+ Child Day Care Centers.

Before a later trip to the Philippines about three years ago, I had completed sixteen different—Six Part Test Sheets. And each test sheet had six columns per page and had ten items per column. And I had a sufficient number of copies printed up, so that I could give one complete set of 16 test sheets to each Child Day Care Worker in each of the 50+ Child Care Centers. And I told these Child Day Care Workers that one of these 16 different Six Part Test Sheets would be picked at random, to test each of their children who were gradating from day care in about three or four months.

And at this meeting with the Child Care Workers from 50+ Centers, I told them they were free to use these “Six Part Test Sheets” as tutoring sheets, to help their children better understand the spoken sounds (phonemes) assigned to the letters in English words.

And I also told these child care workers that if the children's parents desired this, that the child care workers could copy the full set of 16 Test Sheets for each child's parents to use at home with their child.

And what was the Child Care Staffs reaction to my requesting that these children's progress in mastering the early phonic sounds assigned to the letters in English words be tested in three or four months?

I over-whelmed many of them.

And at a break in this meeting, a number of these Child Day Care Workers came up to me and said I was asking too much from them. And several brought along their 160 page booklet, where each page had one picture, and below this Picture was its three letter word.

And they told me that the most difficult words were the first ones, that began with the letter A. And they told me that there were seven of these words that started with the letter A. And that I should throw many of them out. And the worst word was the first word: Ace. And that Ace made no sense to them in a phonic way. And I thanked them for their observations, and their information, and said I would have to give what they told me some thought and some study. (The word Ace starts with a long a. And in Ace, the letter c is given its second sound of: s-s-s. And the word Ace ends with a silent e.) Thus they were right, the word Ace is a poor place to start with when attempting to teach English phonics to beginners.

(I thought I had previously told most of the Child Day Care Workers to put off trying, to teach words that began with a vowel. And to start with words that started with a consonant, and then had a short vowel, and then ended with a consonant.).

But in thinking about this I realized that I had made several errors. I wrongly assumed that these Child Day Care Workers knew the difference between a vowel and a consonant. And I was asking for trouble by starting my list of 160 three letter words with seven words that started with the letter A. And these words were: ace, add, ant, ape, arm, art, and ax. And in these seven—three letter words, the letter a has three different spoken sounds: (short, long, & “R-controlled”).

And in thinking about the above appropriate criticism, I realized that I had to do a number of things. And in time, this led to the ideas that are the core of this invention.

And the things I thought I needed to do were:
1.) Reorganize the 160 three letter words so that the easy words come first, and the more difficult words were introduced much later.
2.) Use a Synthetic phonics approach, where you start with only six to ten letters of the alphabet, and teach the child, each letter's name, and each letter's. assigned brief spoken sound, its phoneme.
3.) And also teach the child how to write each of these six to ten letters at the same time that the beginning reader is learning the name of that letter, and is also learning its most common brief spoken sound (its phoneme).
4.) And drill and practice daily with these 6 to 10 letters in two—thirty minute periods for two weeks, before adding one more additional letter per day.
5.) And realize that many single letters, especially vowels, are assigned more than one brief spoken sound (one phoneme).
6.) And to avoid confusing beginning readers; beginning readers should first learn only a letter's most common brief spoken sound.
7.) Then have beginning readers practice and drill with these six to ten letters for two week, until they know them, and their assigned brief spoken sounds quite well.
8.) Try to find more than one way to help teach a beginning reader the most common brief spoken sounds that are assigned to the consonants and to the five short vowels.
9.) Try to find ways later—to teach that each of the five full time English vowels: a, e, i, o, and u may have four or five brief spoken sounds (phonemes) per vowel, and that these same vowels may also be silent under certain conditions.
10.) Search the printed literature and the web or internet, to try to find out how the above problems have been addressed and worked with in the past.
11.) Try to find one or several ways to help beginning readers learn to always start on the left side of a word; and scan the letters of that word in a left to right direction; sounding out the brief spoken sounds of each letter, as they move from left to right.
12.) Try to find a way to give each brief spoken sound of each single consonant, and each single vowel, a printed “approximate” brief spoken sound of one, two, or three letters, for each spoken sound that is assigned to that letter.
13.) Also include the direct teaching of the brief spoken sounds assigned to the three main types of digraphs: (consonant digraphs, long vowel digraphs, and diphthongs [vowel blends]). And this is to start after the beginning reader has learned the most common brief spoken sounds of the single consonants and the spoken sounds of the short vowels.
14.) Be aware that some beginning readers need much more in the way of practice and drill than other beginning readers of similar background.
15.) Develop a simpler diacritic marking system to help beginning readers be able to identify the brief spoken sounds assigned to the various vowel spoken sounds.
16.) Help others become aware that we learn best when we get immediate feedback from our responses, as this immediate feedback helps us immediately correct or unlearn our errors.
17.) Be aware that bright children and dull children can both learn new things fairly rapidly; but it takes much longer for dull children to unlearn their errors.
18.) I still believe that there is much value in the simple mechanical, durable, and inexpensive Feedback Teaching Machine that I developed in the early 1970's and therefore I have developed some instructional sheets to help teach the spoken sounds of letters (See FIG. 16 as an example of this.).

And from the thoughts, questions, and ideas outlined in paragraphs #1 to #18 above, I developed the concepts and materials that are a part of this current invention.

And what was the outcome of the initial testing of the graduates of the 50+ Child Day Care Centers near the end of the school year? 1.) Several of the Day Care Centers Choose not to participate in the testing. 2.) Of those Child Day Care Centers that choose to participate in this testing, over 600 graduates were tested by a random selection of one of the 16, Six Part Test Sheets.
3.) And the average scores of these 600+ six year olds on the Six Part Test were reported to be between 7.0 and 8.2 (out of a possible 10) on each of the six sub tests.
4.) And a few children were reported to have made perfect scores on all six sub-tests. (Or ten correct answers were made on each of the six sub-tests.)

And a few weeks after the start of the school year, one Child Day Care Center, called North Central Day Care Center, got permission from the North Central Elementary School principal to go into the first grades, to again re-test over 20 of their graduates, randomly with one of the 16 Six Part Tests. A goal was to find out how much of the early English phonics knowledge their graduates had remembered after a three month vacation. And it was verbally reported to me that on this second testing early in the first grade, their scores on the Six Part Tests were very similar to what they were near the end of their last day in day care. And that a few of their graduates again made perfect scores on all six parts of this test at the beginning of first grade. (10 answers correct on each of six sub tests)

And I also paid for a second testing near the end of the next school year. And the number of students tested was similar. And the average test scores of this class of day care center graduates on the six parts of this Six Part Test, were very similar to the scores of the previous year.

(And in a later meeting with Child Care Workers from the 50+ Child Day Care Centers, some of these persons told me that they thought the 16—Six Part Tests were a useful tool for teaching English phonics to their children, and they were glad to have them, and use them, and share them with parents of their children.

And one of the unplanned outcomes was that some first grade teachers in the elementary schools in this community recommended to the parents of children who started first grade with no knowledge of English phonics, was that these children with no knowledge of English phonics be sent to a day care center near that elementary school where they would get a more intense program in learning English phonics than in first grade. And that when this child had learned some English phonics they would again be enrolled in the first grade.

In the Philippines there are 65 local languages. And English phonics is used to teach these local languages. When the USA took over the Philippines from Spain in 1898, one of the first actions of the USA administrators was to recruit over 600 elementary teachers from the USA to work in local Philippine communities to teach English, and to also learn the local spoken language. And these 600 teachers were to then write the local spoken language words in the English phonics they knew. Thus the Philippine People now use English phonics for reading and spelling the local languages, regardless of what part of the Philippines they are located in. (The Spanish taught only Spanish to a few of the native Philippine children. And in the Philippines they had no written languages of their own.)

### BRIEF SUMMARY OF THE INVENTION

I see Progressive Synthetic Phonics as a new way to help beginning readers learn to read by the combined use of a number of components, which include:
1.) The use of a phonics method that uses Synthetic Phonics. Here synthetic means made up from parts, that when combined in the correct sequence or in the correct relationships, help to create a new or different structure. Thus in a synthetic phonics method of learning to read, the beginning reader first learns only a few (6 to 10) names of some of the letters of the alphabet. And each beginning reader is given 6 to 10 small cards with One letter printed on each of these 6 to 10 cards. But at the same time the beginning reader is learning the name of each of these 6 to 10 letters, he or she is also being taught the most common brief spoken sound (phoneme) assigned to each of these first 6 to 10 letters. To avoid confusing beginning readers we limit the numbers of letters they are expected to learn in the first two weeks to 6 to 10 letters.
2.) And what I am adding that is new, is that each of these brief spoken sounds (phonemes) is represented as a printed cluster of: one, two, or three side by side letters below the name of that letter. (See FIGS. 1, 7, & 20 for details.) And that when the spoken sounds of these small side by side printed letter clusters are blended together, they give the “approximate” brief spoken sound (phoneme) of that larger single letter that is printed above these letter clusters, on the same card, or same printed sheet that also contains a picture. And this printed cluster of: one, two, or three smaller printed letters are located below the large single printed letter on the same card, or on the larger printed sheet with a picture+a three letter word. See FIGS. 11, 12, and 13 that show printed sheets of letters or digraphs, where under each letter or digraph is printed its small letter cluster that when sounded out approximates the brief spoken sound of that letter. And these sheets in FIGS. 11, 12, and 13 are designed to be cut into rows with a scissors or paper cutter. And then each of these rows are then cut into small individual letter cards, that can be used to build three letter (and longer) words. And copies can be made of FIGS. 11, 12, and 13 so the original remains intact for later similar use in making additional copies that can be cut into individual small cards.
3.) And what I am adding that is new, is that on the same sheet there are: 1.) a picture of an object or an action that can be spelled with a three letter word; 2.) the printing of that three letter word below that picture; and 3.) that printed below each of the letters in each three letter word is a cluster of: one, two or three letters, that when “sounded out” approximate the brief spoken sound of the larger single letter above this cluster.

And the first words to be worked with and played with are eight to ten words with the numbers: 1, 2, 3, 4, 5, 6, 7, 8, 9, and 10. And each of these words is printed below a picture of that word (And the remaining three letter words, #11 to #160 are treated in the same manner.) And these ten words are the first ten words in the 160 three letter words to be worked with by beginning readers. And the beginning letter of each of these 160 three letter words follows the letter sequence shown in FIG. 7; and also follows the number sequence shown in FIGS. 8 & 9.

And in this set of 160 pages (or pictures) of three letter words, the first 123 pictures have printed three letter words that largely have a printed pattern of: Consonant-Short Vowel-Consonant. (And this is called a C-SV-C pattern) And most of the first 123 of these 160 three letter words are printed in this C-SV-C pattern. And the printed words below pictures #124 to #160 have long vowels, silent vowels, R-controlled vowels, the vowel diphthongs -oy as in boy and toy, and of as in oil; and the second sound of the letter c which is s-s-s in the words ice and ace.
4.) And at the bottom of the picture pages of many of these three letter words is a horizontal arrow with a large dark dot on the left hand side of this arrow; and a point is on the right hand side of this arrow. And in this composite picture that has: 1.) three letters that spell the name of the object or action in that picture, and 2.) one letter cluster is under each of the three letter; and 3.) below the letter clusters is an arrow; and 4.) the beginning reader is told to always start on the side (left side) that has the large dark dot; and move letter by letter to the right side of the three letter word that has the arrow point. And each beginning reader is then asked to explain this to another person, and tell the other person why this is done this way.

And if all goes well in the first two weeks with our beginning readers, we then introduce one new letter and its spoken sound, and the printed cluster of one, two, or three letters that “approximate” the printed sound of the newly added letter. And the usual rate of introduction of one new letter is every one or two days. And with the introduction of each new letter, we continue to have the beginning readers continue to use the previous letters, and the previous pictures in their various forms.

The goal, is to have much practice and drill with these initial six to ten letters and their phonemes, by building known words and new words with these 6 to 10 letters. And another goal is to have these beginning readers learn 1.) the names of these 6 to 10 letters, and 2.) learn the brief spoken sounds that are assigned to each of these 6 to 10 letters; so that each beginning reader will have these letter names, and the spoken sounds of these letters available at an automatic level of memory and awareness; and 3.) learn the brief spoken sounds made by the letter clusters that are printed below each letter, that gives that letter its brief spoken sound (its phoneme).

Automatic memory is when this information is automatically available to us at a subconscious level of awareness, and we do not have to stop and scan our memory for the right or correct answer.

And after the first 160 three letter words have been largely mastered, we then progress on to four and five letter words; and then progress to multiple syllable words, and especially to multiple syllable words that are composed of: prefixes, word roots, and suffixes. And we move on to “word families” where the beginning reader learns about rhyming words. And with these longer and more complex English words, we continue learning about the letter patterns of words in the patterns described previously under headings: 1.), 2.), and 3.).
5.) And a further step in mastering English phonics is to learn the spoken sound of syllables. And often this can best be done by studying the prefixes, word roots, and suffixes of multiple syllable words. And with the mastery of the spoken sounds and the meanings of syllables, the beginning reader had advanced beyond the level of a beginning reader to become a more fluent reader who can manage the phonetic evaluation of many multiple syllable words.

And as we move on into multiple syllable words, the Schwa sound of uh is most often found in the non-dominant syllables of multiple syllable words.

An example of the Schwa spoken sound is in the word: America, which is often pronounced: Uh-mer-uh-cuh. (Three Schwa sounds)

And after the beginning readers have mastered the spoken sounds of the first 160 three letter words, we can introduce irregular or “non-phonic words”. And English is said to have about 3500 irregular words that are in common use. And some educators consider words that contain the Schwa sound of uh as a word with an irregular spelling pattern.

But in the first for the first 10 to 14 days, the focus for beginning readers is learning very well: 1.) the name of 6 to 10 printed letters; 2.) the brief spoken sound (phoneme) assigned to each of these six to ten letters; and 3.) and learning the approximate spoken sound of the printed letter clusters of two or three letters that are placed under each letter in a three letter word. And to help facilitate learning the brief spoken sounds of these letter clusters of two or three letters, each child is given 6 to 10 small paper cards that each have a printed large letter near the top of the card; and printed below each letter on each card, is a cluster of two or three letters that when blended together, “approximates” the brief spoken sound most commonly assigned to that letter. (See FIGS. 11, 12, 13, 19, 20, 21, & 22 for details)

Thus the goal in the first two weeks is to give each beginning reader an understanding of the structure of English words, and of how most English words can be sounded out letter by letter, if you know the most common brief spoken sound (phoneme) assigned to each letter.

And to help achieve this goal, in the first 10 to 14 days the beginning reader is given paper sheets that: 1.) contain on the top a picture of an object or an action; and 2.) below each picture of the object or action are three letters that name that picture; and 3.) below each of these three letters is a 2 or 3 letter cluster, where the blending of the spoken sounds of these 2 or 3 letters together in a left to right manner produces the brief spoken sound (phoneme) assigned to that letter.

And to help achieve this goal in the first two weeks, the beginning reader is given six to ten (#1 to #10) pictures whose spoken name contains three of these 6 to 10 letters. And the beginning reader is helped to place the proper three letters under this picture in the proper sequence to give the written name of that picture. (See FIGS. 19 & 20 for an illustration of this.)
6.) And variations of these printed sheets that contain: 1.) a picture, 2.) a three letter word that describes that picture, and 3.) clusters of two or three letters below each of the three letters that name that picture are used. And with these modified sheets the beginning reader is to place the proper letter card of a letter at the location of a blank line. And some of these blank lines are present in the place of one of the three letters that names that picture. And other blank lines are present where blank lines have replaced one cluster of two or three letters. And some of variations of these pictures contain just three blank lines under that picture. (Please see FIGS. 4, 5, and 6 for details.)

And after the first ten to fourteen days of practice and drill, and use of these first 6 to 10 letters, and blending the phonemes assigned to each of these letters together to learn to make up the full spoken sound of a few words that contain these 6 to 10 letters; then one new letter and its assigned brief spoken sound (phoneme) are added every day or two, until all of the single letters have been introduced. And after the names of most of the letters, and their most common assigned brief spoken sounds have been learned, then the multiple spoken sounds of the single vowels: a, e, i, o, & u can be taught. And then the spoken sounds to the digraphs can be taught in a similar way. And the types of digraphs are: consonant digraphs, long vowel digraphs, and diphthongs [vowel blends].
7.) The process described above, where parts of this process of learning phonics by a synthetic phonic method are printed on sheets of paper or plastic, and where a number of precise holes have been punched in each sheet that correspond to the shallow and deep holes in the Feedback Teaching Machine. This combination, plus a punching sheet, plus a pencil with a cone shaper tip, give the user corrective feedback, when this instructional sheet is properly positioned within this teaching machine. And where a “punching sheet” underlies each Feedback Instructional Sheet, so that when an object with a cone shaped tip (a sharpened pencil or a ball point pen) Is pushed through a punched out hole in the instructional sheet, the student gets immediate feedback as to their correct and incorrect responses. When the cone shaped tip of a pencil produces a large hole in the punching sheet, this means that a correct choice has been made. And when the cone shaped tip produces a small hole in the punching sheet, this means that an incorrect choice was made. And immediate feedback as to our correct and incorrect choices enhances the learning process. (See FIGS. 17 & 18 for details)
8.) And an additional part of this invention is to add a simplified diacritic marking system to help beginning readers understand the various vowel spoken sounds and silent vowels. (See FIG. 14 for details.)
9.) And another additional part of this invention is to use sixteen—Eight Part Review and Test Sheets. And each of these Review and Test Sheets can be used as a teaching or tutoring sheet in a one to one with another person, and can also be used as a test sheet to find out how much the beginning reader understands about English phonics. (See FIG. 10 for details.)
10.) One of the longer range goals with Progressive Synthetics Phonics is that beginning readers become effective advanced readers. And thus in time, beginning readers should learn how to manage multiple syllable words, by separating the multiple syllable word into its separate syllables, and if they do not know a syllable, that they be able to sound it out, in a sequential left to right way. And a desirable part of being able to read multiple syllable words is to be able to have some understanding of the meanings of the different syllables. And this helps to understand the meaning of that multiple syllable word. And an illustration of how this can be done in shown in FIG. 23.

### BRIEF DESCRIPTION OF THE SEVERAL VIEWS OF THE DRAWINGS

FIG. 1. is a copy of an 8.5″×11″ sheet of paper upon which are printed: 1.) the page number; 2.) the picture of an object (or action); 3.) the printed word that describes that object or action; 4.) one, two,or three letters of the alphabet that when sounded out together, “approximate” the most common brief spoken sound (phoneme) assigned to the letter above this letter cluster of: one, two, or three letters. And 5.) is an arrow with a dark circular disk on its left hand side, and a point on its right hand side. The purpose of this arrow is to give the beginning reader the direction in which the letter sequence is to be read and sounded out in reading English words (e.g. from left to right). And plus signs are placed between the letter clusters that give the most common approximate brief spoken sounds for the letter above a letter cluster. And the plus sign is to indicate to the user, that these brief spoken sounds are to be added or blended together in a left to right manner to give the letter above this cluster its approximate spoken sound.

FIG. 2. is a composite made up of the first four sheets that are used to help beginning readers learn the names of some of the single letters of the alphabet, and also learn the most common brief spoken sounds assigned to the single letters in these words. Figure two uses the same size of sheet as Figure one, an 8.5″×11″ sheet of paper. (Composite means made up of distinct parts.)

FIG. 3. is a composite made up of the first nine sheets that are used to help beginning readers of English words learn the names of the letters of the alphabet, and to also learn the most common brief spoken sounds assigned to each of these single letters. With a scissors, a parent or teacher can cut this sheet into nine smaller sheets that can be used in a variety of ways.

FIG. 4. is very similar to FIG. 2, except that FIG. 4 has omitted one letter in each of four—three letter words. This is a kind of “test sheet” to see if the beginning reader can remember the letter sequence in each of these four—three letter words. And then write in the missing letter. To make this sheet reusable many times it can be laminated between two sheets of plastic, or placed in a transparent plastic sheet protector type of envelope. And the student user is then to mark on the transparent plastic surface with water soluble ink from a felt tipped pen. And after each use, the water soluble ink can be wiped away with a damp cloth. And this makes this sheet reusable.

FIG. 5. is similar to FIGS. 2 and 4, except that the blank area is indicated by a short horizontal line that is in the lower part, where the letter clusters that approximate the spoken sounds of the single letters that are above these clusters are located. Thus the question is: can the student remember the letter sequence pattern of a letter cluster that gives the approximate spoken sound of the single letter above this letter cluster? And this sheet can be made reusable by the methods described in FIG. 4, above.

FIG. 6. is similar to FIGS. 2, 4, and 5. But FIG. 6 differs from FIGS. 2, 4, and 5, in that it has only three blank spaces below the picture of an object or an action. And the challenge to the beginning reader is: can the beginning reader remember the spelling pattern of the three letter word illustrated by the picture above these three blank lines? And can the student also write in these three missing letters? And this sheet can be made reusable by the methods described under FIG. 4.

FIG. 7. is a copy of the proposed letter and digraph sequence used in Progressive Synthetic Phonics (also called Hart's Progressive Phonics), where 54 letters or digraphs are located in two columns. At the top of each column is a symbol for the numbers that are written below. And also at the top of each of the two columns are the headings of: 1.) “Letter or Digraph”; and 2.) the second heading of: “Approximate spoken sound (phoneme)”.

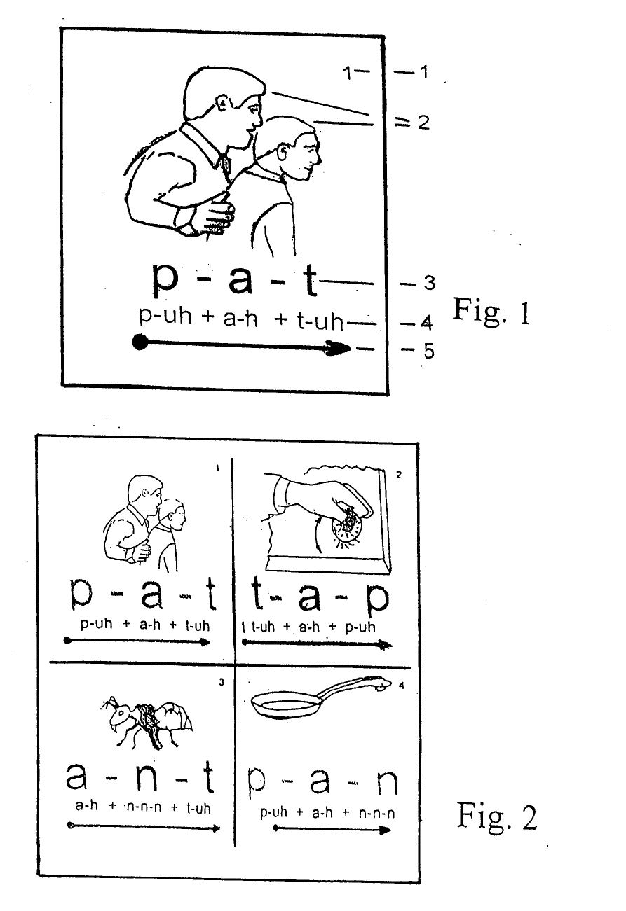

And as one scans each column, you can note the number given to that letter on the left hand side of the column; and to the right of each number is that number's letter or digraph. And to the right of each letter or digraph is an equals sign. And to the right of each equals sign, are indicated the approximate spoken sound or sounds assigned to that letter or digraph—in written form.

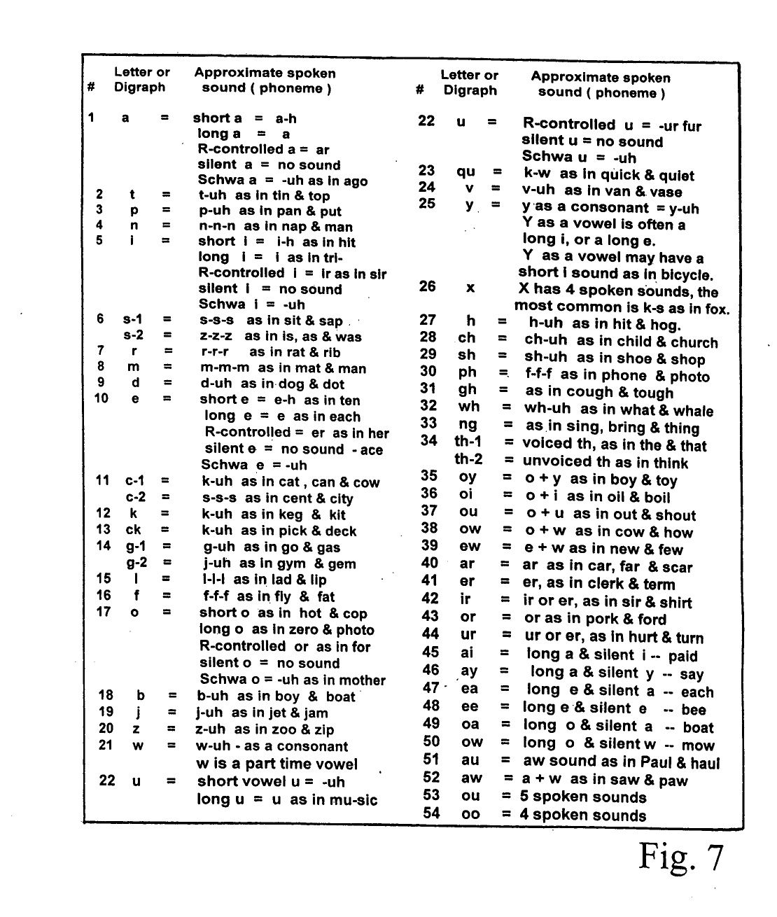

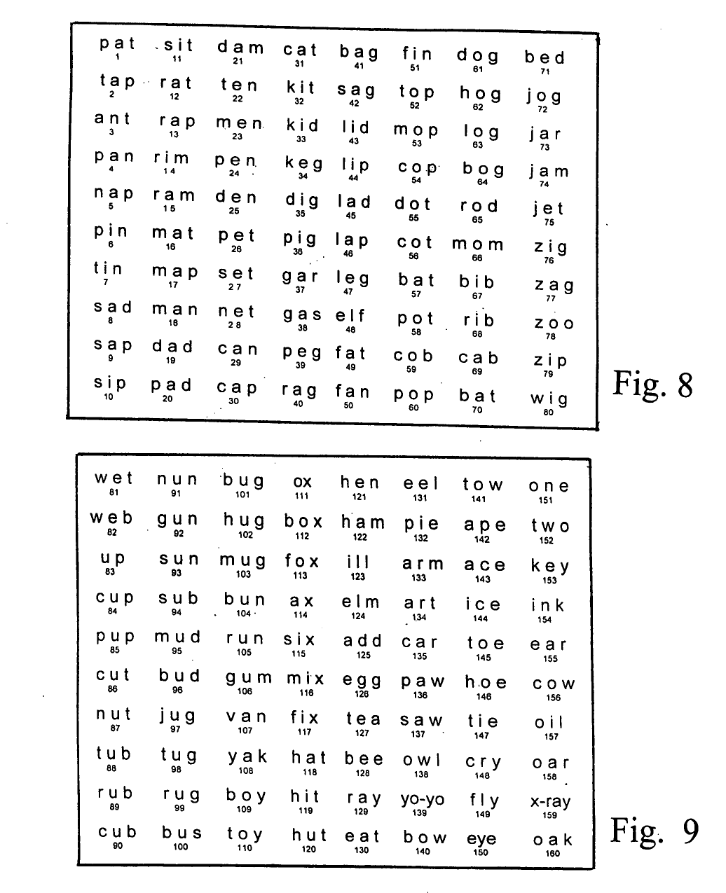

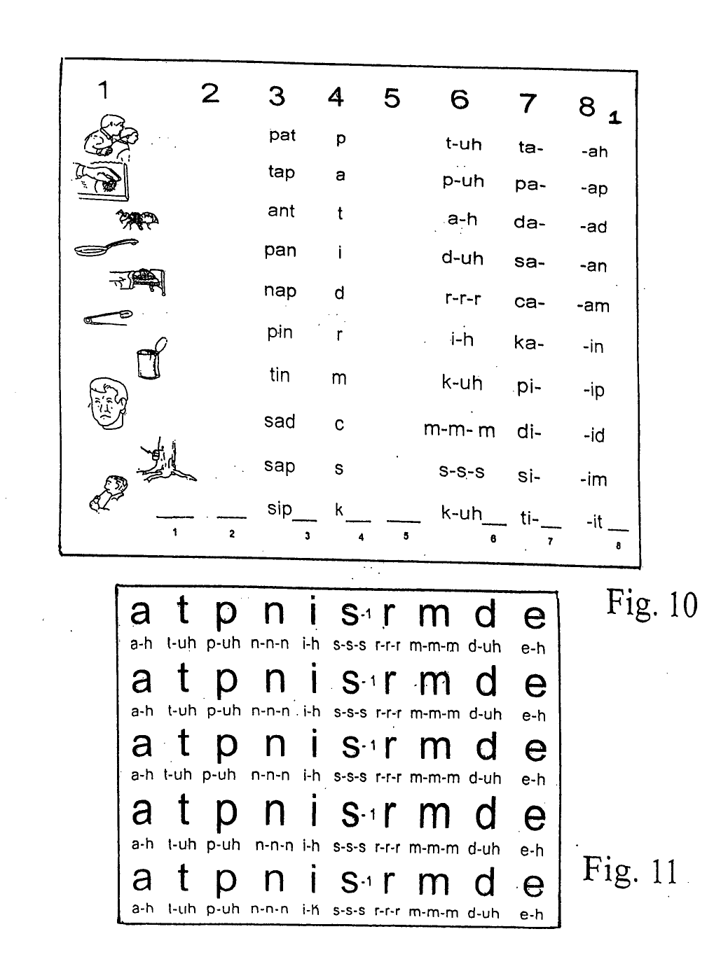

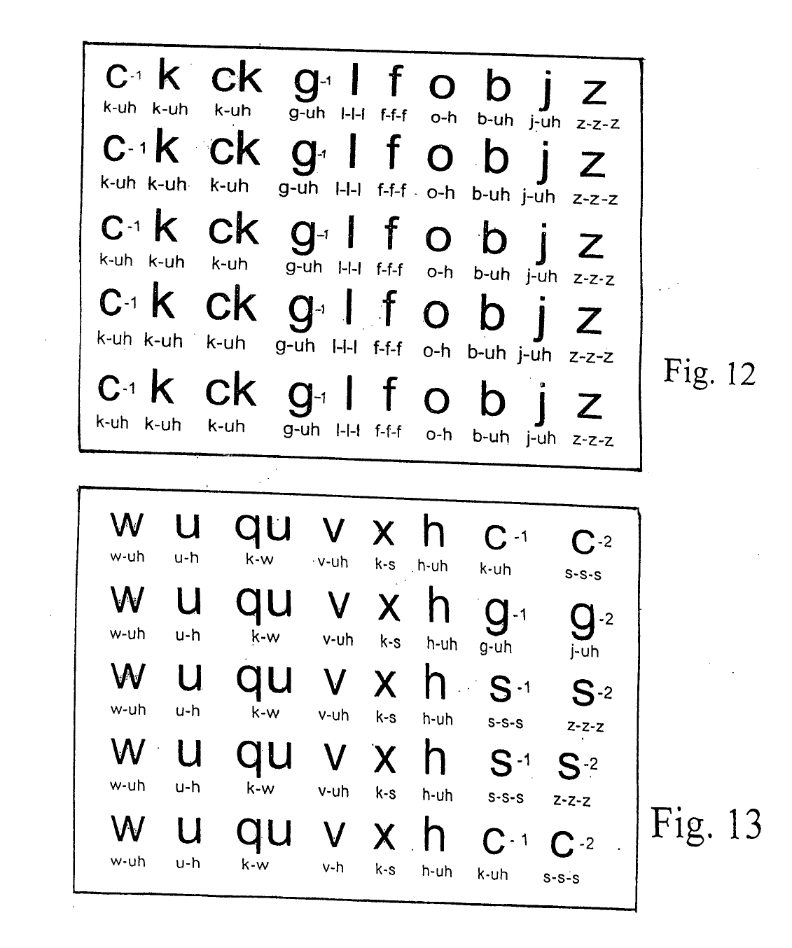

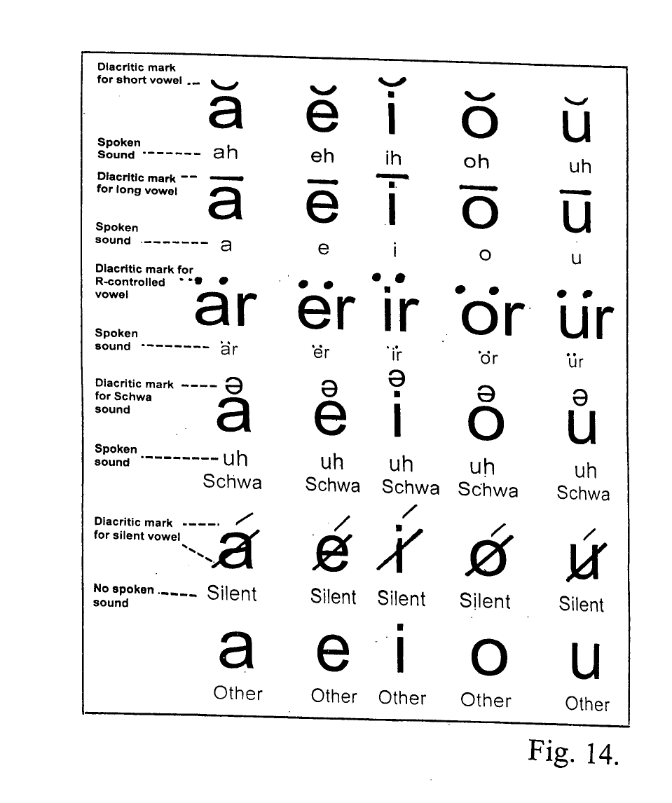

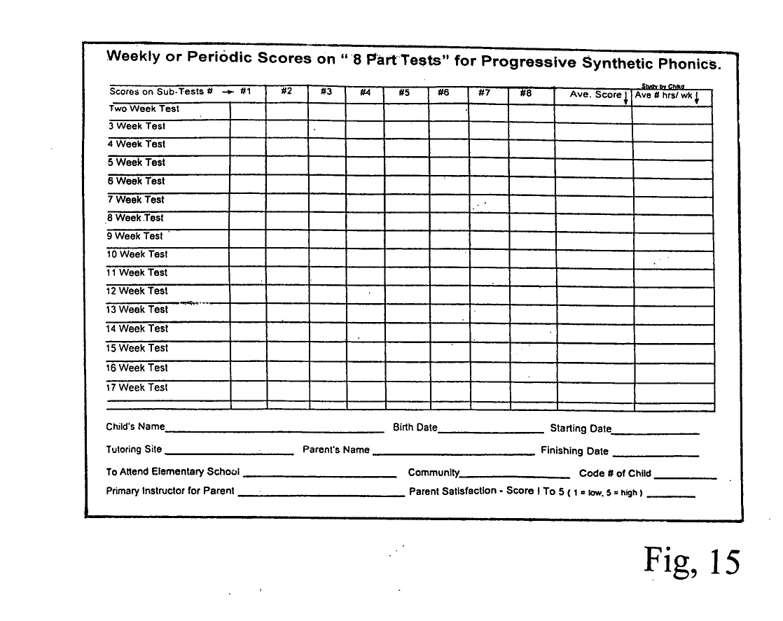

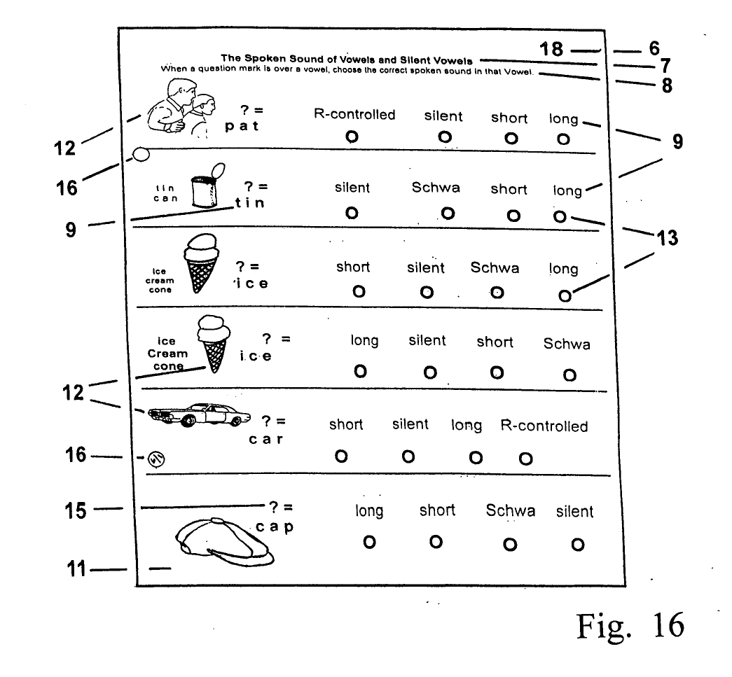

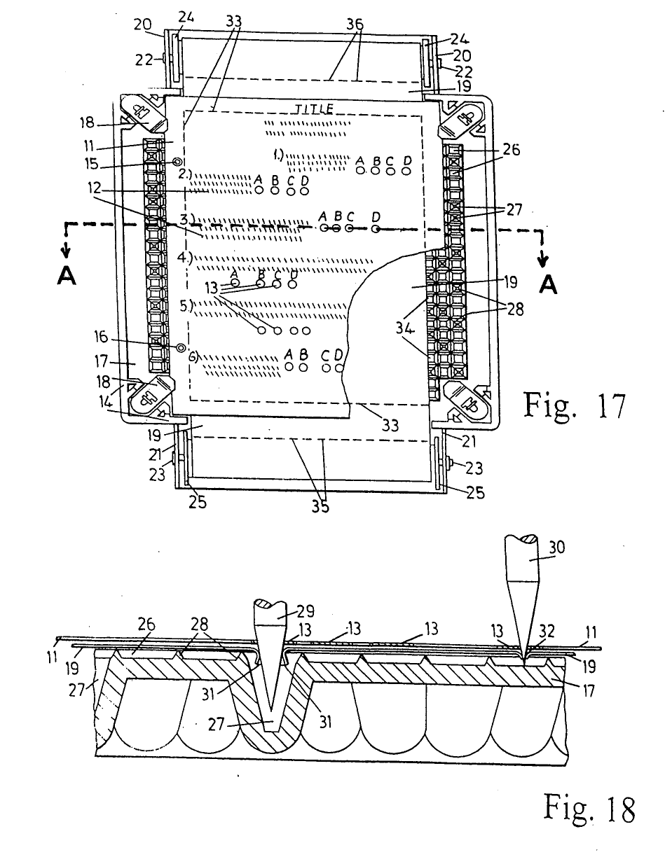

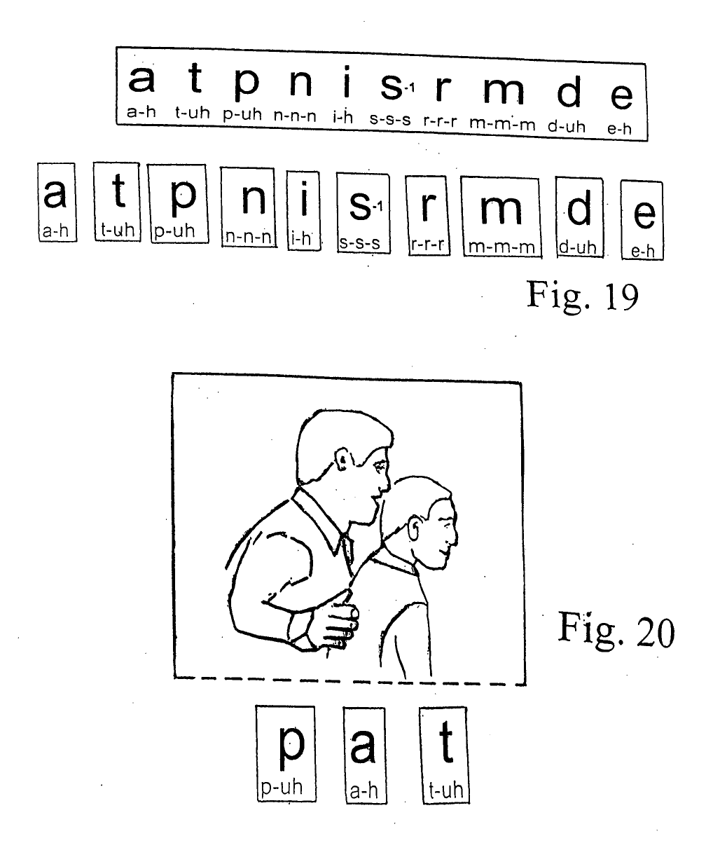

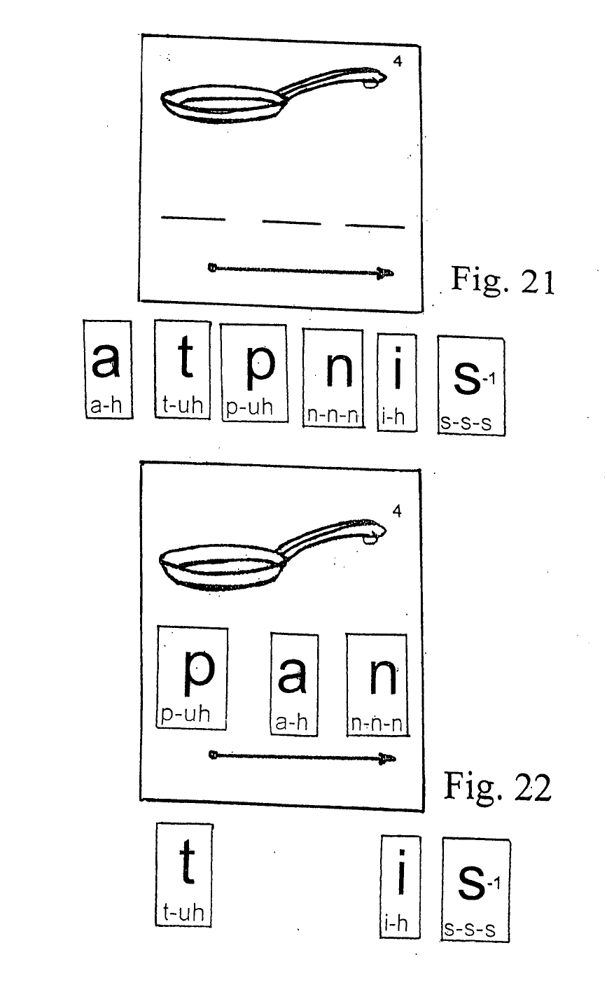

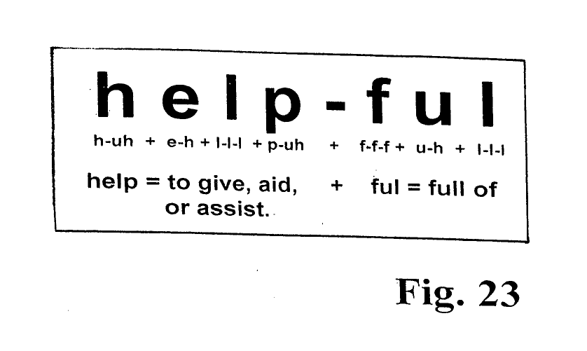

The purpose of the chart with two columns in FIG. 7, is to give some pattern of organization, and a reasonable sequencing of the letters and digraphs to help beginning readers learn the brief spoken sounds (phonemes) assigned to each letter and each digraph. And this chart also gives the parent, teacher, or tutor, an understanding of the letter clusters that “approximate” brief spoken sounds (phonemes) assigned to the individual letters and individual digraphs.

FIG. 8 is a listing of the first eighty—three letter words used in Progressive Synthetic Phonics. And most of these first eighty—three letter words have a letter pattern of: Consonant-Short Vowel-Consonant. Exceptions to this C-V-C pattern are the words: gar; elf, jar, and zoo.

FIG. 9 is the second eighty—three letter words, are words #81 to #160. And words #133 to #160 have more difficult spelling patterns with: long vowels, silent vowels, “R-controlled vowels”, and diphthongs (vowel blends). These more difficult spelling patterns are put last in these 160 three letter words to lessen confusion for the beginning readers of English words.

FIG. 10 is an illustration of the first of 16 “Review and Test Sheets” that has eight columns of items per sheet, that pertain to learning the assigned spoken sounds of the letters of the alphabet. There are sixteen such Review and Test Sheets in this set of Review and Test Sheets. The reason for sixteen Review and Test sheets is that there are 160 three letter words at the start of Progressive Synthetic Phonics. And each sheet covers ten three letter words; and 16×10=160. And these Review and Test Sheets follow the numbers of the sequence of the 160 pictures that show objects or actions. And in the #1 sheet of this Review and Test Sheet are shown the first ten pictures in this set of 160 pictures of three letter words. And in a similar manner Review and Test Sheet #2, shows the second ten pictures, from items #11 to item #20.

And the first challenge to the student is to give the spoken name of the ten pictures in the first column in sheet #1 of the Review and Test Sheets.

And the second challenge to the beginning reader is to read the ten three letter words in column #3 of Review and Test Sheet #1.

And the third challenge to the beginning reader is to draw a line from the picture in column #1 to the three letter word in column #3, that best describes or names of that picture.

And in column #2 the student should make ten lines, where each line connects the picture of an object or action in column 1, with its printed name in column 3.

And the fourth challenge to the beginning reader is to name each of the ten letters in column #4, and also verbally give the most common spoken sound assigned to that letter.

And the fifth challenge is to have the beginning reader give the spoken sounds of the two or three letter clusters in column #6 (which approximate the most common spoken phonemes assigned to the first 10 of the 26 letters in English words.)

And the sixth challenge to the beginning reader is to draw a line between each of the ten letters in column #4, and the approximate spoken sounds made by each of the ten letter clusters in column #6. (These lines will be in column 5.)

And the seventh challenge to the beginning reader is to blend a consonant spoken sound with a short vowel spoken sound, (ten times) as these ten consonant+short vowel combinations that are shown in column #7.

And the eighth challenge to the beginning reader is to blend a short vowel spoken sound with a consonant spoken sound ten times, as these are shown in column # eight.

One of the goals of these sixteen similar Review and Test sheets is to give the beginning reader a way of practice and drill in learning about the brief spoken sounds assigned to the single letters of the English alphabet. And these sixteen sheets can also be used as test sheets to quickly determine how well a beginning reader understands the brief most common spoken sounds (phonemes) assigned to the letters of the alphabet.

And similar sheets can be prepared for the three main types of digraphs, and for multiple syllable words.

FIG. 11 shows the first ten letters to be learned in Progressive Synthetic Phonics, and these are: a, t, p, n, i, s, r, m, d, and e. And located below each of these ten letters is printed an “approximation” of its most common brief spoken sound (its phoneme). And five rows of the same ten letters are printed on one 8.5″×11″ sheet. And it is our intention that the user make copies of this sheet, and then cut each copy into five rows; where each row contains the ten letters at the top, and that beneath each letter is printed its “approximate brief spoken sound.” And the teacher, tutor, or parent can then use a scissors to cut each row into ten separate letters. And these ten letters can be used three or more ways. One way is in a one to one with a tutor or mentor, where the child will first speak the name of a letter, and next, the beginning reader will speak or give the brief spoken sound assigned to that letter. And a printed “approximation” is shown below each letter in this listing of ten letters.

And each beginning reader should be told that the vowels in this group are: a, i, and e. And the beginning reader should also be told that the approximate spoken sounds below the letters: a, i, and e, are called short vowel sounds. And the beginning reader should be told that we learn the short vowel spoken sounds first. And the beginning reader should also be told that the reason for the small #1 to the right of the letter s means that s has two brief spoken sounds, and that we learn the brief spoken sound of s-s-s first.

And another way to use these individual letters is to have beginning readers build three letter words with them. And these may be the same words they are learning from the first ten pictures of the 160 three letter words in Progressive Synthetic Phonics. And the beginning reader may place these single letters above or on each of the blank lines in each of the four pictures in FIG. 6, to spell each word.

And the teacher or parent should realize that in the beginning the individual child will understand only a little of what they are being told when the teacher or parent talks about the above. But in time, and with practice, and with the use of these separate letters of the alphabet, the beginning reader will grasp more and more of the details, if these details are clearly explained often enough. Don't expect the beginning reader to learn and remember everything after just one lesson, or after one exposure.

The individual consonants: t, p, n, m, and d have only one spoken sound each, and when put in print, these are: t-uh, p-uh, n-n-n, m-m-m, & d-uh.

The letter r is different. When the letter r follows a vowel, it takes over much of the sound of that vowel. This makes that vowel an “R-controlled” vowel”.

When the letter r comes before a vowel, it has the approximate consonant spoken sound of r-r-r.

FIG. 12 is similar to FIG. 11, and is to be used in the same way as the letters in FIG. 11. When looking at the letters in FIG. 12, from left to right, they follow the letter sequence of numbers 11 through 20 in FIG. 7. I have chosen to put the two letters: c-1 and k beside the consonant digraph ck because they all have the same brief spoken sound of k-uh. It should be noted that c-1 is the first brief spoken sound of c. The three consonants: c, g, and s, each have two spoken sounds assigned to them. And in FIG. 12, only their first spoken sound is shown. The letter o is a vowel, and here only its short vowel spoken sound of o-h is shown. The single consonants: l, f, b, and z have only one spoken sound each, and it is shown below that letter. Thus: l=l-l-l, f=f-f-f, b=b-uh, & z=z-z-z.

The letters in FIG. 12 are to be used in the same way as the letters in FIG. 11 are used.

FIG. 13 is a continuation of the single letters of the alphabet, with the exception of the letter combination qu. In English words the letter q is always followed by a u. And the spoken sound of qu is k+w, (or: k-uh+w-uh—in Progressive Synthetic Phonics.).

The first spoken sounds of c, g, and s, have been shown in FIGS. 11, & 12.

The second spoken sounds of c, g, and s, are shown in FIG. 13 in the two right hand columns of letters. And: c-2 is s-s-s, as in cent & city; and g-2 is j-uh, as in gem & gym; and s-2 is z-z-z, as in: is, as, his & was.

FIG. 14 is a grid pattern way of showing the four of the spoken sounds I have assigned to each oh the five full time vowels: a, e, i, o, and u, and also showing that each of these full time vowels can also be silent under-certain circumstances.

To give the short spoken sound of the vowels: a, e, i, o, & u, I have attached the letter h, so that the approximate printed short spoken sound of each of the five full time vowels is: a-h, e-h, i-h, o-h. & u-h.

The long spoken sound of the five full time vowels is their name: a, e, i, o, & u.

To show that a vowel spoken sound is controlled by the letter r when an r follows a vowel, I have chosen to illustrate this by placing two dots over that vowel.

The Schwa spoken sound of a vowel is always uh or u-h, and its diacritic mark is always an upside down e

To show that a vowel is silent, I have chosen to place a diagonal line through that vowel, as is illustrated in FIG. 14.

FIG. 14 also shows the five diacritic marks that I have chosen to assign to the five full time vowels. The diacritic markings for: short vowels, long vowels, and also the Schwa sound of vowels are the conventional markings for these three types of vowel spoken sounds. Using two dots over a vowel to show that it is an “R-controlled” vowel is less common.

And I have placed a diagonal line through each of the silent vowels.

And under each vowel in this grid I have written the approximate spoken sound for a vowel of that type with this particular vowel letter.

FIG. 15 is a copy of the Summary Sheet for the Weekly or Periodic Scores on each of the 16 Review and Test Sheets for these 160 three letter words. With this sheet a summary can be compiled on each beginning reader as they make weekly or periodic progress in their mastery of early phonic knowledge and skills.

Each of the sixteen Review and Test Sheets is constructed in the same format, with eight vertical columns, with ten items per column. And at the bottom of each column is a short horizontal line that can be used to record the number of correct responses in that column.

Each column evaluates a slightly different type of knowledge and/or skill that pertain to awareness of, or knowledge of English phonics.

Some educators may criticize this approach of using a printed sheet as a teaching aide, and later using this same sheet as a test. This has been called “training the child to take the test”. However if the beginning reader learns the answers to the 80 questions on each of these 16 Review and Test Sheets, he or she, will have acquired and remembered much information about the early parts of English phonics. The goal is to help the child learn the answers to the questions on these 16 Weekly or Periodic Review and Test Sheets, so why not use them for practice and drill.

And a summary record of the Weekly or Periodic Review and Test Sheets can inform another teacher, tutor, or parent as to the results of this child's work, over a span of time in learning about how well a child understands English phonics.

And for a knowledgeable teacher, a summary record may indicate what are the next appropriate steps for that child to take in the area of gaining a more complete understanding of English phonics.

FIG. 16 is a copy of a sheet that can be constructed and used in two different ways to help beginning readers learn about English phonics.

The first way is the conventional way, where the beginning reader uses this sheet after it has been placed in a transparent plastic envelope to make it reusable. And the beginning reader then places an “X” mark with water soluble ink over the circle they believe is the correct answer. And then another person with better knowledge about English phonics can then scan the beginning readers answer choices, and note which choices are correct and which are incorrect. And then this evaluator is to give feedback to the beginning reader as to their correct and incorrect responses. And the evaluator can then use a damp cloth to wipe off the water soluble ink from the transparent plastic surface. This makes this sheet reusable many times.

The second way to use this sheet is to use a special punching mechanism that has a pattern of punches that are arranged to punch holes at the precise locations through this sheet where the dark circles are printed to indicate answer choices.

And this sheet is then properly located in a Feedback Teaching Machine (see FIGS. 17 and 18 for details and an illustration of how this mechanism works.)

Briefly the student user or another person then places a blank sheet of paper between this instructional sheet and a grid of shallow and deep holes that are molded into in the upper surface of the Feedback Teaching Machine. And the user then uses a sharpened pencil (with a cone shaped tip), or a ball point pen, to push through the round holes (previously punched in this instructional sheet) at the locations that the user believes are the correct answers.

All of the sheets in a set or series of instructional sheets are precisely printed, and precisely punched so that all correct answer choices lie directly above a deep hole in the grid of deep holes and shallow holes in the molded upper surface in the Feedback Teaching Machine.

And all incorrect answers are precisely printed on the printed instructional sheet in a pattern that places all incorrect responses above a shallow hole in the upper surface of the Feedback Teaching Machine.

And when a pencil with a cone shaped tip is pushed through the punched out circles of an instructional sheet, this cone shaped tip results in large holes in the punching sheet at correct responses, and small holes in the punching sheet at all locations of incorrect responses. (See FIG. 18 for details.).

And this Feedback Teaching Machine, when used with correctly printed and punched instructional sheets, gives users immediate feedback, as to their correct and incorrect responses. And immediate feedback enhances many learning experiences.

FIG. 17 is a drawing of my Feedback Teaching Machine from one of my earlier patents that shows the use of two spools on which are wound a long narrow sheet of punching paper. And between these two spools, #24, and #25, this sheet of punching paper #19, covers part of the upper surface of the grid of shallow and deep holes that are molded in the upper surface of the Feedback Teaching Machine #17

The use of the spools are to allow the advance the punching sheet about one half of an inch after each use; and to prepare the machine for use by another student with the same instructional sheet. (Turning a spool pulls the holes in the punching sheet under the instructional sheet, and this makes this machine ready for the next user.)

Placed above this punching sheet of paper #19 is an instructional sheet #11, that Is similar to the instructional sheet shown in FIG. 16.

And in FIG. 17, number 11 indicates an instructional sheet; which contains printed questions #12, and sets of four punched holes #13, where one of the holes #13 lies directly above a deep hole 27, and three holes lie directly above shallow holes #26 in the upper surface of the Feedback Teaching Machine. And #15 and #16 indicate positioning pegs protruding upward from the upper surface of the feedback teaching machine. And two punched holes along one side of instructional sheet #11, are positioned over pegs #15 and #16, to assure the proper positioning of this instructional sheet #11.

A broken line A-A indicates a cross section line through the Feedback Teaching Machine along the path of line A-A, and also a cross section through punching sheet 19, and Instructional sheet 11.

FIG. 18 shows a part of the cross section along line A-A, in FIG. 17. And FIG. 18 shows how the user of the feedback teaching machine with an instructional sheet 11 on its upper surface, and with punching sheet 19 sandwiched between instructional sheet 11 and upper surface 17 of the Feedback Teaching Machine, can provide immediate feedback to the user, when the user uses cone shaped tip 29 or 30, as with a pencil, or a ball point pen.

And FIG. 18 shows how shallow holes 26, permit the tip 32, of cone shaped tip 30 to penetrate punching sheet 19 only a short way. And this short distance produces a small hole in punching sheet 19.

And FIG. 18 also shows how deep holes 27, permit the tip 31 of cone shaped tip 29 to penetrate through punching sheet 19, producing a much larger hole in punching sheet 19.

And FIG. 18 shows how holes 13 punched in instructional sheet 11 are placed over shallow holes 26, and deep holes 27 in the upper surface 17 of the Feedback Teaching Machine.

And in printing and punching holes in instructional sheets 11, the key is to always print the sheets and punch holes in these sheets so that correct responses lie over the deep holes; and so that incorrect responses lie over shallow holes.

FIG. 19 shows one strip of letters that has been cut from the five rows of letters from the sheet shown in FIG. 11. And under this strip are individual letters that have been cut from a similar strip. And one of the uses of these individual letters is described below, and is illustrated in FIG. 20.

FIG. 20 shows the picture of a three letter word on one sheet of paper, where the three letters that spell the name of that word have been folded under the upper part of that sheet. (And this folded site is indicated by a dotted line.) And where three separate letters that are on small paper cards are positioned under that sheet in a sequence that spells the name of the word in the picture. And to check to see if the beginning reader has selected the correct letters. And these three letters are placed in the correct left to right sequence to name that word. And the beginning reader may lift up the top sheet, and unfold the bottom part to see if the letters they have placed below that sheet match those letters, and the letter sequence that are printed on that sheet.

FIG. 21 is similar to FIG. 6, except FIG. 21 has six small individual letters located beneath the picture, and these small individual letters are the first six of the first group of ten letters as are illustrated in FIG. 19. And the user is to pick the correct three letters, and is to place them over the three blank horizontal lines in their correct position to spell p a n as is seen in the picture below in FIG. 22. FIG. 22 illustrates how FIG. 21 has been modified by a user taking three of the letters from the six letters below the picture in FIG. 21, and placing them in their correct positions over the three blank lines within the picture, to spell the name of that picture.

FIG. 23 illustrates a way of helping students learn the syllables, including the prefixes, word roots, and suffixes of English words, by dividing these words into their syllables with a short line; and have under each letter in each syllable, the small printed letter cluster, where each letter cluster approximates the brief spoken sound (phoneme) of the single letter above each letter cluster; and below the letters clusters are written the simple definitions of each syllable. And it should be recognized that in time, a goal of English phonics is to have readers of English words rapidly recognize the many common syllables that make up many English multiple syllable words. And the above shows one way to introduce this learning process, as a part of Progressive Synthetic Phonics.

### DETAILED DESCRIPTION OF THE INVENTION

Through my clinical and consultation work in the area of child and adolescent psychiatry, starting in 1957, I became aware that regardless of the primary presenting problem of the child or adolescent, that about 50% of the children and adolescents that I was asked to see and treat, had in addition, a significant problem with learning to read English words and sentences. And this happened year after year.

And I often wondered how much this very poor ability to read English words and sentences, contributed to the underlying cause of the primary presenting problems of these children and adolescents.

And this repeated observation led me to a life long search or odyssey, as to what were the underlying problems for this reading disability; and what could be done to lessen the frequency and severity of these reading problems that apparently were so common.

And under sub-heading #5.) Background of Current invention I have given numerous details of this ongoing search for the reasons for this common problem, and also details of my ongoing search for a better solution, or a better way to help beginning readers learn to read.

And between 1970 and 1980, I took 95 graduate hours in education, reading, educational research, and related subjects in education at the University of Missouri at Kansas City, to try to gain a better understand to the roots of this common problem of some children having a poor ability to read English words and sentences.

And the 1970's were an era of Programmed Teaching and Learning, and also the common use of teaching machines. And it appeared to me that the use of teaching machines held much promise to give individualized instruction in a programmed way that should help remediate many of these learning problems.

And one of the outcomes of my taking graduate work in the area of education at UMKC, was there was an increase in the demand or request for my work time as a child psychiatric consultant with four different school districts in the Kansas City area. And I worked with and served these four school districts in a variety of ways.

And one of the things I observed was, although many schools had purchased teaching machines, they were often unused or little used. And as I talked with teachers about this they gave a variety of reasons for this lack of use of their teaching machines. And in time, “Learning Centers” were set up that contained most of these teaching machines.

And one of my colleagues and co-workers was Ms Marjorie Farrel, Director of Special Education for the Kansas City, Mo. School District. And one day I asked her why these many teaching machines were so under utilized, when it appeared they promised much benefit for children with reading disabilities.

And Ms Farrel listed the many problems with most of the teaching machines then in use. And some of these were: 1.) frequent break down; 2.) long delay in getting them repaired; 3.) were large in size; 4.) often made distracting noises; and 5.) interfered with the group instruction the teacher was giving the entire class.

And previously Ms Farrel had helped me understand that most of the reading impaired children were in regular classrooms, and that only the most severely impaired were placed in special classes for the learning disabled, and this only included children in grades four and higher. And that reading impaired children in second and third grades were almost always in regular classrooms.

And in discussing this further, Ms Farrel said: “What we really need in the way of a teaching machine is: something small, durable. quiet in operation; simple to use; Inexpensive; and that each child can keep in his or her own desk—to work with at their own desk.” And when she told me this, I knew she was right.

And the following semester at UMKC, I took a graduate course in Educational Technology. And it was taught by Husseini Eltogby, Doctor of Education. And our textbook ran about 700 pages, and often this book had only one bit of educational technology on one page. And one of our assignments was to review, and report on 20 to 30 U.S. Patents, or patent abstracts in the area of Educational Technology. And Linda Hall Library had bound copies of patent abstracts dating from about 1900 And Linda Hall Library was and is located next to the UMKC campus.

And I saw these patent abstracts as a kind of intellectual feast for me to devour, and assimilate, in my quest for a better way to help children and adolescents learn to read English words and sentences. And within a year or two my searches through these patent abstracts led directly to my filing for my first patent, which was granted Jul. 24, 1973, with U.S. Pat. No. 3,747,229. And I call this my Feedback Teaching Machine. And an improved version of this patent is shown in FIGS. 17 & 18 in this patent application.

And as I evaluated hundreds, if not thousands, of children and adolescents for a variety of problems, regardless of the nature of the presenting problem, about 50% also had a serious problem with reading English words and sentences. And I often did a simple phonics test with each of these children or adolescents. And almost all of these children who had serious reading problems did very poorly on this English phonics test.

And I concluded that one of the better ways to teach English phonics was to start with three letter words, and to stay with three letter words until the child had mastered most of the phonics of the letters in these three letter words. And in the early 1970's I located 120 three letter words that could be easily illustrated by a picture of an object or an action.

And I then made sets of instructional sheets for my Feedback Teaching Machine that utilized these 120 three letter words, plus a picture of each word. And I saw these 120 three letter words as the initial steps for teaching and learning English phonics. And I shared these feedback teaching machines, and these sets of instructional sheets that I had designed to teach English phonics with a number of teachers in the elementary schools where I was a consultant.

And in general, the teachers I gave them to, liked the feedback boards, and the sets of instructional sheets that focused on learning the spoken sounds (phonemes) of three letter English words. And a few of these teachers wanted one teaching machine for each student in their class. But though this was an ultimate goal, at the start, I did not have this much material in terms of Feedback Teaching Machines and in terms of sets of instructional sheets.

So I sought a less expensive option. And this was to have these same 120 three letter words plus a picture of each word printed on sheets of 8.5″×11″ paper. And these sheets could be posted on the wall or blackboard. And later I reduced the size of the picture plus its three letter word, so that four of these pictures plus their three letter word could fit on one sheet of 8.5″×11″ paper. And many teachers found these useful.

And I decided that I wanted my Feedback Teaching Machine, plus the sets of instructional sheets designed to teach English phonics, tested or evaluated in a controlled research way with the use of statistics to find out how really helpful they were in helping children learn English phonics. And initially a number of educational administrators were supportive of the idea of such a study. But then they looked at the amount of teacher time, and the time of other professionals such a study would take. And they said their budgets would not permit the kind of study I wanted done, as it would take too much time—and therefore too much money.

And they wanted me to pay for the expenses of such a study. And I did not have the kind of money they indicated was needed to do this type of study. And I was unable to find another source that would support such a study. And when I talked with several businesses about selling these materials, they wanted to know how effective they were, when used in a classroom. And I could give them only testimonials from some of the teachers. But testimonials were not adequate to support their sale. And about this time, teaching machines had fallen out of favor.

And the new promise was that computers would meet this need. But in the 1970's and early 1980's the use of computers in this way, by educators was only a thought and a wish on the horizon.

And in the mid 1980's, when school let out in June of each year, there was a request or demand for my work time as part time staff, or as a consultant with several residential treatment centers, psychiatric hospitals, and habilitation centers. And when I signed on for a yearly contract with these organizations in June, I found that I had progressively less time available for my work as a consultant to elementary schools and school districts after the mid 1980's.

And in the mid and late 1970's I tried to sell these Feedback Instructional Materials to elementary schools by way of sending descriptive literature to the directors of special education in many elementary schools in many states in the USA. And I lost money on this business venture. So I decided to put my Feedback Instructional Materials “on the shelf”, with the plan of returning to them full time after I retired from my work as a child psychiatrist.

But one day in the mid 1980's I was talking with a long time friend, John Shipper MD, who had recently retired to La Union Province in the Philippines. And I shared my frustration at not getting adequate research studies done to show that these teaching materials were helpful for beginning readers, and for reading disabled children and adolescents. And John Shipper MD said to me, “Bring your instructional materials to La Union Province in the Philippines, and we can have them evaluated there and produced there for less money than in the USA.” And I followed John Shipper's advice. And many of the events that followed are given in “5.) Background of the Current Invention”—in more detail.

And some of these events covered under “5.) Background—” include:
1.) The flawed research study of 2 second grades in 2 different elementary schools.
2.) The unplanned study where a four year old boy who used these instructional materials daily on week days, for two years, was reading between fifth and sixth grade level, half way through first grade, at age six years.
3.)The local Rotary Club setting up a literacy committee to decide what to do with the information about the benefit of these instructional materials. And their decision to see if some of the local Child Day Care Centers for 3 to 6 year olds were interested in using these materials with their pre-school age children to learn some English words and some English phonics.
4.) Finding out that there were over 50 Child Care Centers in this community.
5.) Telling the Child Day Care Staff of these Child Day Care Centers that I would like to have their six year olds tested before they graduated from Day Care.
6.) My being told from many of these Child Day Care Center Staff that I was expecting too much from them, and that the use of these 160 three letter words was poorly designed when I arranged these 160 three letter words in an A to Z sequence.
7.) And that it was bad judgment on my part to have three letter words that began with the letter a to start with; as the letter a, with its multiple spoken sounds was very confusing to the child day care workers, and to their children.
8.) And I realized that these Child Day Care Workers were correct in their observations.
9.) And my decision was to again look for a better way to have English phonics be taught.
10.) And by reviewing many, many web sites on the internet that pertained to teaching English phonics, I gained additional knowledge about English phonics.
11.) And finding a booklet by Hazel Logan Loring, published in 1980, that suggested that by adding the Schwa sound of -uh to many consonants, their phoneme can be more clearly spoken verbally.
12.) And by reading a book by: Carl A. Lefevere, published in 1961, where he explains that there are actually three types of consonant spoken sounds.
13.) And my deciding to add the letter -h to English short vowels, as this helps us to approximate their short vowel spoken sounds.
14) And my decision to add printed clusters of letters below all single letters and all single digraphs, is from my observations and belief that this should help beginning readers better approximate the brief spoken sounds (phonemes) assigned to the single letters and to the single digraphs.
15.) And I have not been able to locate in my searches that anyone else that has presented the idea of using clusters of: 1, 2, or 3 letters to express all of the brief spoken sounds (phonemes) of all of the 26 letters of the alphabet, and all of the three main types of digraphs. (And from my review of a large number of sources, I think that Hazel Logan Loring, came closest in her 44 page monograph: Teaching Blend Phonics in First Grade; where she suggested adding the Schwa sound of uh to many consonants. (But this uh spoken sound does not fit the continuant or the resonant consonants.)
16.) And part of the ongoing problem is the English Language itself. English uses the 26 letters of the Latin alphabet to express its many spoken sounds. But language experts do not agree on how many different actual spoken sounds (phonemes) are present in English spoken words: some say 44, some say 53, and some say over 60.
17.) And to add to the confusion of the beginning reader, each of the five full time vowels have four or five different spoken sounds, or may be silent;. And the two part time vowels; y & w, are also part time consonants. And the consonants: c, g, & s each have two different brief spoken sounds (two phonemes). And the letter X has four spoken sounds. And we have three types of digraphs, where two side by side letters together give only one spoken sound (one phoneme). And we have two digraphs that may have four or five spoken sounds each, depending upon the word they are located in—for details see FIG. 7, numbers 53 and 54.
18.) And a common current way to let another person know you are referring to the phoneme of a single letter is to place this letter between two diagonal lines, so that the spoken sound of the letter b is /b/; and the spoken sound of d is /d/. But this does not work very well for: c, g, s, x, y, w, and the full time vowels.
19.) And one of the problems with the spelling patterns of English words is that now about 3500 common English words have a non-phonic spelling pattern. This is because as the spoken patterns of English words evolved or changed, most often the older spelling patterns were kept. And these changes in the spoken sounds of English words most often involved the vowel spoken sounds.
20.) And in the 1920's some of our bright scholars in Elementary Education at Columbia University in New York City, and the University of Chicago, in Chicago, thought that this was too much confusion to try to teach beginning readers. And so they introduced the Whole Word Method of learning to read English words. And the Whole Word Method largely or totally ignored English Phonics until about the 1990's when they started giving “lip service” to English phonics, and teaching a minimal amount of English phonics.
21.) But ignoring English phonics caused many crippled readers, who in the fifth grade and higher could not sound out multiple syllable words in a phonic way. And these crippled readers often became school drop outs, and illiterate adults—unless they had special help during which they were taught some English phonics.
22.) And from my observations, the Whole Word Method of reading English words became like a giant educational cult, which sought to dominate how beginning readers were taught to read English words. And they gained positions of power and influence in the educational departments of reading at many or most universities, and also in the public school systems of many states and cities.
23.) But many private schools and Roman Catholic elementary schools persisted in teaching English phonics to beginning readers. And they had far fewer illiterate eighth grade graduates than did the public schools.
24.) Thus when I sought to find a better way to help beginning readers learn to read English words my early focus was to try to find a better way to help beginning readers learn English phonics. And I thought that learning the brief spoken sounds assigned to three letter words was a good place to start.
24.) But some of the child day care workers in La Union Province in the Philippines gave me a helpful awakening, that proceeding from A to Z caused many problems. And they pointed out to me that the word Ace was a very poor word to start with in teaching English phonics. And this caused me to search further for a “better way” to help beginning readers learn English phonics.
25.) And this led me to the ideas I have outlined in Progressive Synthetic Phonics, where I felt it was possible and desirable to have the brief spoken sound (phoneme) of each letter or digraph written under that letter or digraph as a letter cluster, that when its letters were blended together approximated the brief spoken sound (phoneme) of the letter above that letter cluster.
26.) And a reasonable goal for beginning readers of English words is that before they enter fifth grade, that they be able to read multiple syllable English words; and that they know and understand many of the common: prefixes, word roots, and suffixes in English words. Most good readers of multiple syllable English words do not attempt to “sound out” the spoken sounds of the individual letters. They have moved beyond this early phase of learning to read, Good readers of English words have mastered the spoken sounds of many prefixes, word roots, and suffixes. But to reach this state of mastery takes time and practice. Thus in FIG. 23, I have given a simple illustration of a way to help beginning readers of English words become better readers, by understanding some of the common: prefixes, word roots, and suffixes, by extending some of the earlier concepts into learning about multiple syllable words.
27.) Thus from information I have shared in the previous pages, my thought and feeling is that it is appropriate for me to file for a US Patent on this method of helping beginning readers learn to read by adding letter clusters below each letter, and each digraph, and where this letter cluster approximates the spoken sound (phoneme) of that letter or digraph. And to do this for all of the single letters of the alphabet, (even those that are assigned multiple brief spoken sounds,) and also for the three major types of digraphs (consonant digraphs, long vowel digraphs, and diphthongs (vowel blends). And these sound clusters for each letter and digraph are best illustrated in FIG. 7. And away to help readers learn about multiple syllable English words is illustrated in FIG. 23.

1. What I claim as new in this invention is a system of teaching English phonics, where each brief spoken sound (phoneme) that is assigned to a single letter or to a single digraph is also represented by a printed cluster of: one, two, or three, side by side letters that are printed adjacent to that letter or digraph; and when the brief spoken sounds of the letters in these letter clusters of side by side letters are blended together in a left to right manner, this cluster of letters gives the approximate brief spoken sound (phoneme) of the single letter or digraph that is adjacent to that letter cluster; and it is recognized that each vowel may have four or five brief spoken sounds assigned to each single full time vowel; and that the consonants letters: c, g, and s, each have two brief spoken sounds (phonemes) assigned to each of these consonants; and that the letter x has four brief spoken sounds assigned to it.)

2. Is when the single letters or single digraphs, and their adjacent letter clusters that approximate the brief spoken sounds (phonemes) as described in claim One, are printed as rows or columns of letters and/or digraphs; on paper or plastic sheets; so that each sheet can be cut into rows or columns of letters or digraphs; and then each of these rows or columns can be cut into small paper or plastic cards, where each card contains a single letter or digraph and where each card also contains a letter cluster that approximates the brief spoken sound (phoneme) of that letter or digraph. And the beginning reader can use these single letter or digraph cards in a variety of ways; such as to build words; to fill in blank spaces to complete printed words; or to tell another person the name of that letter or digraph, and to also tell another person the brief spoken sound of the particular phoneme that has been assigned to that letter, or digraph. (See FIGS. 11, 12, 13, 14, 19, 20, 21, and 22 for details.)

3. is where the basic concepts in claims one and two are applied to helping beginning readers of English words to understand the spoken sounds assigned to common syllables, such as: prefixes, roots words, and suffixes; such as in FIG. 23; where in this situation each of the letters of a prefix, word root, or suffix, has a cluster of letters printed adjacent to each of the single letters or single digraphs in that: prefix, word root, or suffix, and where these adjacent clusters of letters give the approximate brief spoken sound of the single letter or single digraph so that when these single approximate brief spoken sounds are blended together in a left to right manner, we get the approximate spoken sound of that: prefix, word root, suffix, or other syllable,

4. is where the concepts in claim One are combined with a group of other elements to form a composite work sheet that includes: 1.) a number, and/or letter, in the upper or lower parts of this composite picture to identify that picture's location in a numbered sequence; and this composite picture is composed of the following parts: 2.) a picture of an object or an action; or a commonly used word; 3.) and under or near that picture are printed the letters of a word that names that picture; 4.) and adjacent to each letter is printed in smaller print, a cluster of one, two, or three letters, that when blended together in a left to right manner give the approximate brief spoken sound (phoneme) of the single letter adjacent to this particular cluster of smaller letters; and 5.) where below these letter clusters is printed a horizontal arrow that has a dark disk like circle on its left side, and an arrow point on its right side; and where the purpose of the arrow is to show the beginning reader the direction in which we read the letters of a word, and also the direction in which we sound out and then blend together the brief spoken sounds assigned to each letter in a left to right manner to give us the spoken sound of that word, and this is illustrated in FIG. 1.

5. is where the invention as described in claims One and Four, is initially introduced to beginning readers of English words, and to others in need of knowledge of English phonics by a Synthetic Phonics Method, where initially only six to ten single letters are introduced; and where the beginning or remedial reader is to learn at the same time: 1.) the name of each of these six to ten letters; 2.) the brief spoken sound assigned to of each of these six to ten letters; 3,) and the spoken sound of a letter cluster of one, two, or three letters, that gives the approximate brief spoken sound (phoneme) of that letter or digraph; and 4.) where it is possible for the beginning reader to learn how to write each of these six to ten letters; first in large print on the black board; and later in smaller print on a sheet of paper. Here synthetic means a larger whole. (the word) is made up of, or composed of smaller parts that are arranged in certain sequences or in certain specific arrangements.)

6. is where in the above invention, after an initial period of one to two weeks, of working and playing with, these first six to ten letters; then every day or two, one new letter (or digraph) and 1.) its spoken name; 2,) its most common brief spoken sound; and 3.) a cluster of one, two, or three side be side letters that when the spoken sounds of this letter cluster are blended together, this blended sound approximates the brief spoken sound (phoneme) of that new letter. And when this new letter or digraph, and its spoken sound (its phoneme) is blended with the sounds of letters or digraphs learned previously, and new spoken words and new printed words are learned; and when the beginning reader continues to use daily practice and drill to come to know quite well the old letters; their names, and their spoken sounds, and to know quite well the printed clusters of old letters and new letters, and to know the approximate brief spoken sounds (phonemes) of the new letters and the older letters. And this enables the beginning reader to read simple words composed of these known letters and digraphs.)

7. Where in the above invention, after the beginning reader has fairly well mastered the most common sounds of the consonants, the short vowels, and the digraphs, by the use of the processes described in the previous claims; that the beginning reader is then be introduced to the multiple sounds of the five full time vowels, and also when these vowels are silent; as they are described and illustrated in FIG. 14; and where beginning readers are also introduced to the second sounds of the consonants: c, g, and s; as they are illustrated in FIG. 13.)

8. The invention as is described in claim one, where “Review and Test Sheets” as are Illustrated in FIG. 10 are used as teaching and coaching sheets and also are used as test sheets; and where each of these sheets has a number of columns, and where one of these columns has printed letter clusters to illustrate in print, the approximate the brief spoken sound (phoneme) of each letter or digraph that is in an adjacent column; and where the student user is to draw a line between a letter or digraph in one column to a letter cluster in an adjacent column; where the approximate spoken sound of each letter cluster can be matched with a letter or a digraph in an adjacent column; and these “Review and Test Sheets”, can be used to evaluate or test a beginning reader's ongoing and progressive knowledge (see FIG. 10, columns: 4 & 6, for details) of the approximate spoken sounds assigned to each of ten of the single letters of the alphabet. But also included in this process of matching, is when a digraph is printed in one column, and this digraph is to be matched with its approximate printed brief printed sound that is located in another column.)

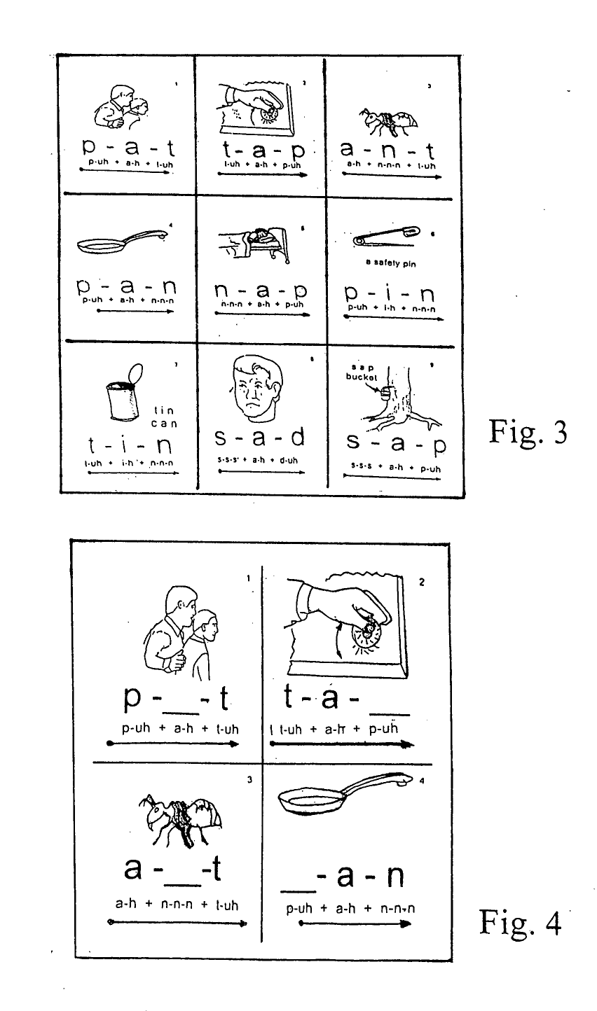

9. The invention as described in claim One, where the work sheets (See FIGS. 1, 4, 5. & 6) and the “Review and Test Sheets” (See FIG. 10) can be made reusable by placing these sheets in a transparent envelope of Sheet Protector type; or by laminating a sheet between two sheets of transparent plastic. And then having the beginning reader mark on these transparent plastic surfaces with water soluble ink. And after another person has checked these sheets for correct and incorrect responses, and has given feedback to the user, then the water soluble ink can be wiped away with a damp cloth, making this sheet reusable many times.)

10. is where any of the instructional sheets or Review and Test sheets can be adapted to the format of the instructional sheets used with the Feedback Instructional Machine that I patented in the 1970's. (And FIG. 16 is an example of this type of printed format.)

11. is where the invention as described in claims 1 and 4, can be used in a way where one or more of the single letters or single letter clusters that are printed under or adjacent to the picture, can be replaced by one or more horizontal blank lines; and where the student user may “write in” the missing letter or digraph, or can use letter cards to replace in the missing letter or digraphs. (See FIGS. 21 and 22 for an illustration of this process.)

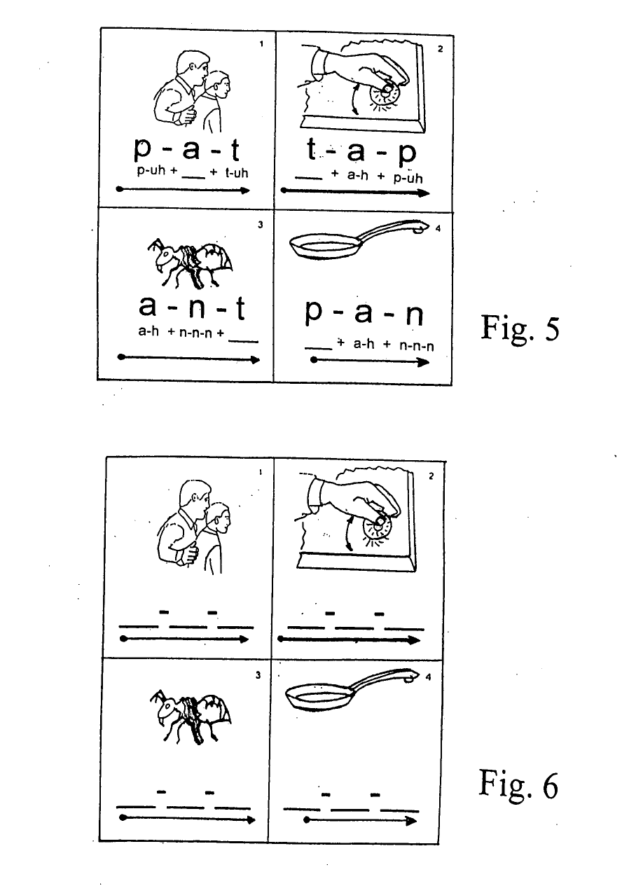

12. is where the invention as described in claims 1 and 4, can have a short horizontal line replace a letter cluster that lies under or adjacent to a single letter or single digraph, and where this letter cluster gives the approximate brief spoken sound assigned to a single letter or single digraph that is shown above or adjacent to this letter cluster; and where the user may write in this letter cluster, or may place a printed letter cluster card over this line that usually shows the approximate brief spoken sound of the single letter or single digraph that is above or adjacent to this line. (See FIG. 5 for an illustration.)

13. is where in the invention described in the previous claims, the initial focus is in having the beginning learner learn: 1.) the names of the letters, 2.) the brief spoken sound assigned to each letter, and 3.) to see and understand how to blend the spoken sound assigned to each letter clusters of: one, two, or three letters, that approximate the brief spoken sound (phoneme) of the adjacent letter; and to start with we use three letter words with a spelling pattern of: Consonant-Short Vowel-Consonant; and after the beginning user has mastered 1.) the spoken letter names; 2.) the brief spoken sounds assigned to each of these letters and 3.) has also mastered the spoken sound patterns of the letter clusters of one, two, or three letters that approximate the phoneme of these letters or digraphs, we then move on to longer words, multiple syllable words, and also learning some of the spelling patterns of Irregular or non-phonic words.
